(19) United States
(12) Patent Application Publication
(10) Pub. No.: US 2014/0334990 A1
(43) Pub. Date: Nov. 13, 2014

(54) ZPGM Diesel Oxidation Catalyst Systems and Methods Thereof

(71) Applicant: Zahra Nazarpoor, Camarillo, CA (US)

(72) Inventor: Zahra Nazarpoor, Camarillo, CA (US)

(73) Assignee: CDTI, Ventura, CA (US)

(21) Appl. No.: 13/904,267

(22) Filed: May 29, 2013

Related U.S. Application Data
(63) Continuation-in-part of application No. 13/891,668, filed on May 10, 2013.

(51) Int. Cl. B01D 53/94; B01J 29/78

(52) U.S. Cl. CPC B01D 53/945; B01J 29/78
USPC 422/177

(57) ABSTRACT

The present disclosure refers to a plurality of methods employed for production of ZPGM diesel oxidation catalyst systems substantially free of PGM, which may include a substrate, a washcoat, and an impregnation layer. Washcoat may include at least one carrier material oxides. An optional impregnation layer component, which may include at least one ZPGM catalyst. This catalyst system may be free of any oxygen storage material (OSM). Suitable deposition methods and firing systems may be employed in order to form disclosed ZPGM oxidation catalyst systems, which may be able to remove main pollutants from exhaust of diesel engines, by oxidizing toxic gases.

### CROSS-REFERENCE TO RELATED APPLICATIONS

This application is a continuation-in-part of U.S. patent application Ser. No. 13/891,668, entitled Perovskite and Mullite-like Structure Catalysts for Diesel Oxidation and Method of Making Same, filed May 10, 2013, which is incorporated herein by reference as if set forth in its entirety.

### BACKGROUND

1. Field of the Disclosure

The present disclosure relates generally to ZPGM diesel oxidation catalytic systems, and more particularly to compositions and methods for production of catalyst systems substantially free of platinum group metals.

2. Background

Since the introduction of catalytic converters in cars and other types of engines, there has been a significant reduction in emissions, preventing release of millions of tons of pollutants into the atmosphere, consequently improving urban air quality with many associated environmental benefits.

New emissions control systems are being developed for fuel efficiency and to lower pollutants from diesel engines, especially for automobiles, utility plants, processing and manufacturing plants, trains, boats, mining equipment, and other type of engines.

A plurality of pollutants in exhaust gases of diesel engines may include carbon monoxide (CO), unburned hydrocarbons (HC), nitrogen oxides (NOₓ), and particulate matter (PM), which may be controlled by using platinum group metals (PGM) converters.

Currently, a plurality of catalyst systems may be generally manufactured using at least some (PGM) capable to meet or exceed the ever stricter standards for acceptable emissions. The demand on PGM continues to increase due to their efficiency in removing pollutants from exhaust systems. However, the high cost of platinum group metals, along with other demands for PGM, places a strain on supplies of PGM, which in turn may drive up costs of PGM, and may increase prices for production of oxidation catalyst systems and catalytic converters.

A need exists therefore, for a diesel oxidation catalyst which does not require platinum group metals, and has a similar or better efficiency as prior art catalysts. The present disclosure may employ methods for producing relatively inexpensive platinum-free catalysts showing significant improvements in nitrogen oxide reduction performance.

For the forgoing reasons, may be highly desirable to have an improved, cost effective catalyst system, which may produce improvements for controlling exhaust emissions achieving similar or better efficiency than existing oxidation catalysts.

### SUMMARY

The present disclosure relates to ZPGM diesel oxidation catalyst systems, which may be used to convert pollutants from exhaust engines into less harmful compounds or pollutants, by oxidation or elimination of these compounds from exhaust streams of diesel engines. ZPGM diesel oxidation catalyst systems may oxidize toxic gases, such as carbon monoxide, hydrocarbons, and nitrogen oxides which may be included in diesel exhaust gases.

In one embodiment, ZPGM diesel oxidation catalyst system may include: a substrate, a washcoat, and impregnation layer. Washcoat may include at least carrier material oxides and may include ZPGM catalysts. Impregnation layer may include ZPGM catalyst. Suitable known in the art chemical techniques, deposition methods and treatment systems may be employed in order to form the disclosed ZPGM diesel oxidation catalyst systems.

In another embodiment, the method for making ZPGM diesel oxidation catalyst systems may include a substrate, a washcoat, and an overcoat, which may be substantially free of platinum group metals. Washcoat may include at least one oxide solid, which may include one or more selected from a group consisting of carrier material oxide, a ZPGM catalyst, or a mixture thereof.

ZPGM diesel oxidation catalyst systems may include Perovskite structures having the characteristic formulation ABO₃ or related structures which may be formed by partially substituting element “A” and “B” base metals with suitable non-platinum group metal in order to form a structure having the general formula A₁₋ₓMₓBO₃. “A” may include yttrium, strontium, or mixtures thereof. “B” may include a single transition metal, including manganese, cobalt, chromium, or mixture thereof. M may include silver, iron, copper, cerium, niobium or mixtures thereof; and “x” may take values between 0 and 1.

Suitable materials for use as substrates may include cordierite, metallic alloys, microporous materials, or combinations.

ZPGM diesel oxidation catalyst system may be formed in one step wash coat processing while washcoat may include carrier metal oxide and ZPGM catalyst with perovskite structure of Y_{1-X}Ag_{X}MnO₃, where x=0-0.5.

ZPGM diesel oxidation catalyst systems may be formed in two steps processing, including washcoat and impregnation layer. Washcoat may include carrier metal oxide and impregnation layer may include ZPGM catalyst with perovskite structure of Y_{1-X}Ag_{X}MnO₃, where x=0-0.5.

These and other advantages of the present disclosures may be evident to those skilled in the art, or may become evident upon reading the detailed description of related embodiments, as shown in accompanying drawings.

### BRIEF DESCRIPTION OF THE DRAWINGS

Embodiments of the present disclosure may be described by way of example with reference to accompanying figures, which may be schematics and are not intended to be drawn to scale.

FIG. 1 shows general methods for ZPGM oxidation catalyst system configurations, according to one embodiment.

FIG. 2 shows simplified flowcharts of methods for preparation of ZPGM oxidation catalyst systems, according to one embodiment.

FIG. 2A shows preparation of washcoat, according to one embodiment.

FIG. 2B shows preparation of impregnation layer, according to one embodiment.

FIG. 2C shows a flowchart for preparation of washcoat by co-precipitation method, according to one embodiment.

FIG. 3 shows CO light-off test results for fresh coated samples of example 1 and example 2, according to one embodiment.

FIG. 4 shows HC light-off test results for fresh coated samples of example 1 and example 2, according to one embodiment.

FIG. 5 shows NO light-off test results for fresh coated samples of example 1 and example 2, according to one embodiment.

FIG. 6 shows a graph comparison of NO conversion during engine dyno emission test, according to one embodiment.

FIG. 7 shows a graph comparison of NO2 generation during engine dyno emission test, according to one embodiment.

FIG. 8 shows a graph comparison of CO conversion during engine dyno emission test, according to one embodiment.

FIG. 9 shows a graph comparison of HC conversion during engine dyno emission test, according to one embodiment.

### DETAILED DESCRIPTION

The present disclosure is hereby described in detail with reference to embodiments illustrated in drawings, which form a part hereof. Other embodiments may be used and/or and other changes may be made without departing from the spirit or scope of the present disclosure. The illustrative examples described in detailed description are not meant to be limiting of the subject matter presented herein.

### DEFINITIONS OF TERMS

All scientific and technical terms used in the present disclosure may have meanings commonly used in the art, unless otherwise specified. The definitions provided herein, are to facilitate understanding of certain terms used frequently and are not meant to limit the scope of present disclosure.

As used herein, the following terms may have the following definitions:

“Catalyst system” refers to a system of at least three layers, which may include at least one substrate, a washcoat, and an optional overcoat.

“Diesel oxidation catalyst” refers to a device which utilizes a chemical process in order to break down pollutants from a diesel engine in the exhaust stream, turning them into less harmful components.

“Substrate” refers to any suitable material for supporting a catalyst and can be of any shape or configuration, which yields sufficient surface area for deposition of washcoat.

“Cordierite” refers to a strongly dichroite blue mineral consisting of a silicate of magnesium, aluminum, and iron material, which may be used for substrate.

“Washcoat” refers to at least one coating including at least one oxide solid which may be deposited on a substrate.

“Overcoat” refers to at least one coating including one or more oxide solid which may be deposited on at least one washcoat.

“Perovskite” refers to a ZPGM catalyst, having ABO₃ structure of material which may be formed by partially substituting element “A” and “B” base metals with suitable non-platinum group metals.

“Oxide solid” refers to any mixture of materials selected from the group including a carrier material oxide, a catalyst, and a mixture thereof.

“Carrier material oxide” refers to materials used for providing a surface for at least one catalyst.

“Oxygen storage material” refers to materials that can take up oxygen from oxygen-rich feed streams and release oxygen to oxygen-deficient feed streams.

“ZPGM Transition Metal Catalyst” refers to at least one catalyst which may include at least one transition metal completely free of platinum group metals.

“Impregnation” refers to a process of totally saturating a solid layer with a liquid compound.

“Platinum group metals” refers to platinum, palladium, ruthenium, iridium, osmium, and rhodium, unless otherwise stated.

“Treating,” “treated,” or “treatment” refers to precipitation, drying, firing, heating, evaporating, calcining, or mixtures thereof.

“Exhaust” refers to discharge of gases, vapor, and fumes created by and released at the end of a process, including hydrocarbons, nitrogen oxide, and carbon monoxide.

“Conversion” refers to the change from harmful compounds (such as hydrocarbons, carbon monoxide, and nitrogen oxide) into less harmful and/or harmless compounds (such as water, carbon dioxide, and nitrogen).

“T50” refers to the temperature at which 50% of a material is converted.

“T90” refers to the temperature at which 90% of a material is converted.

### DESCRIPTION OF DRAWINGS

In the following detailed description, reference is made to the accompanying illustrations, which form a part hereof. On these illustrations, which are not to scale or to proportion, similar symbols typically identify similar components, unless context dictates otherwise. The illustrative examples described in the detailed description, are not meant to be limiting. Other examples may be used and other changes may be made without departing from the spirit or scope of the present disclosure.

General Description ZPGM Catalyst Systems

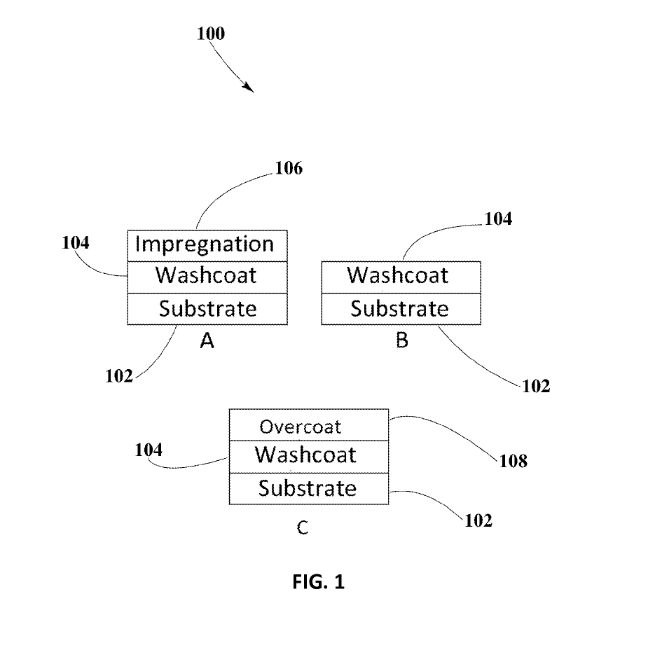

FIG. 1 depicts a general description of ZPGM catalyst system 100 configurations, according to various embodiments. As shown in FIG. 1A, ZPGM catalyst system 100 may include a substrate 102, a washcoat 104, and an impregnation layer 106, where washcoat 104 or impregnation layer 106, or both, may contain active oxidation ZPGM catalyst components. FIG. 1B shows an embodiment of ZPGM catalyst system 100, which may includes a substrate 102 and a washcoat 104 without impregnation layer 106 where washcoat 104 contain active oxidation ZPGM catalyst components.

According to one embodiment, FIG. 1C shows a catalyst system, which may include substrate 102, washcoat 104, and an overcoat 108, where washcoat 104 or overcoat 108, or both, may contain active oxidation ZPGM catalyst components which is substantially free of platinum group metals.

According to an embodiment, active oxidation ZPGM catalyst components may include a perovskite structure having the general formula ABO₃ or related structures resulting from substitution of A and B base metals, which may be partially substituted with non-PGM transition metals.

Partial substitution of the A site with M element can yield the general formula A₁₋ₓMₓBO₃. “A” may include yttrium, strontium, or mixtures thereof. “B” may include a single transition metal, including manganese, cobalt, chromium, or mixture thereof. M may include silver, iron, Cerium, niobium or mixtures thereof; and “x” may take values between 0 and 1. The perovskite or related structure may be present in about 1% to about 30% by weight.

Substrate

Substrate 102 of the present disclosure may be, without limitation, a cordierite material, honeycomb structure, where substrate 102 may have a plurality of channels with suitable porosity. Porosity may vary depending on particular property of substrate 102 employed. Additionally, the number of channels may vary depending upon the type of substrate 102 used.

For metallic honeycomb substrate 102, the metal may be without limitation, a heat-resistant base metal alloy, particularly an alloy in which iron is a substantial or major component. The surface of metal substrate 102 may be oxidized at elevated temperatures above about 1000° C. to improve corrosion resistance of alloy by forming an oxide layer on the surface of alloy, which may also enhance adherence of washcoat 104 to surface of substrate 102.

In one embodiment, substrate 102 may be a monolithic carrier having a plurality of fine, parallel flow passages extending through monolith. The passages can be of any suitable cross-sectional shape and/or size. The passages may be, for example without limitation, trapezoidal, rectangular, square, sinusoidal, hexagonal, oval, or circular, although other shapes may be also suitable. The monolith may contain from about 9 to about 1200 or more gas inlet openings or passages per square inch of cross section, although fewer passages may be used.

In another embodiment, substrate 102 can also be any suitable filter for particulates. Wall flow filters may be similar to honeycomb substrates 102 used for diesel exhaust gas catalysts. Honeycomb substrate 102 may be used for automobile exhaust gas catalysts, in which the channels of wall flow filter may be alternately plugged at an inlet and an outlet to force flow of exhaust gases through the porous walls of flow filter, while traveling from inlet to outlet of wall flow filter.

Washcoat

Washcoat 104 may be formed by suspending carrier metal oxides in water to form aqueous slurry, which may be deposited into substrate 102 as washcoat 104. The washcoat 104 may include one or more carrier material oxide or at least one oxygen storage material. Suitable carrier material oxides may include ZrO₂, doped ZrO₂ with Lanthanide group metals, Nb₂O₅, Nb₂O₅—ZrO₂, alumina and doped alumina, TiO₂ and doped TiO₂ or mixtures thereof. A suitable oxygen storage material (OSM) may be a mixture of ceria, zirconia, and lanthanum or ceria, zirconia, neodymium, and praseodymium. Other components may optionally be added to aqueous slurry, such as acid or base solutions or various salts or organic compounds, which may be added to aqueous slurry to adjust the rheology of slurry and enhance binding of washcoat 104 to substrate 102. Some examples of compounds which can be used to adjust rheology may include, but are not limited to, ammonium hydroxide, aluminum hydroxide, acetic acid, citric acid, tetraethylammonium hydroxide, other tetraalkylammonium salts, ammonium acetate, ammonium citrate, and other suitable compounds known in the art.

The washcoat 104 may include one or more ZPGM catalyst component. The ZPGM catalyst in washcoat 104 may be prepared by co-precipitation, co-milling 226 or any other suitable deposition methods known in the art. The ZPGM transition metal salt or salts may be precipitated with, but is not limited to NH₄OH, (NH₄)₂CO₃, tetraethylammonium hydroxide, other tetraalkylammonium salts, ammonium acetate, or ammonium citrate. Subsequently, the precipitated transition metal salt or salts and washcoat 104 may be deposited on substrate 102 followed by a firing 208 cycle for about 2 hours to about 6 hours, at a temperature of about 300° C. to about 900° C. ZPGM catalyst component and carrier material oxide in washcoat 104 may be milled together. The milled catalyst and carrier material oxide may be deposited on substrate 102 in the form of washcoat 104 and then treated.

Various amounts of washcoat 104 of present disclosure may be coupled with substrate 102, preferably an amount which may cover most of, or all surface area of substrate 102. In one embodiment, about 80 g/L to about 250 g/L of washcoat 104 may be coupled with substrate 102.

Washcoat slurry 222 may be placed on substrate 102 in any suitable manner. For example, without limitation, substrate 102 may be dipped into slurry, or slurry may be sprayed on substrate 102. Other methods of depositing slurry onto substrate 102 known to those skilled in the art may be used in alternative embodiments.

Impregnation

Impregnation layer 106 may be typically applied after treating washcoat 104, but treating is not required prior to application of impregnation layer 106 in every embodiment.

After washcoat 104 and substrate 102 are fired 208, they may be cooled to about room temperature. Subsequently, washcoat 104 and substrate 102 may be cooled, washcoat 104 may be impregnated with at least one impregnation 216 component. The impregnation 216 component may include, without limitation, a transition-metal salt or salts being dissolved in water and impregnated on washcoat 104. Following impregnation 216, washcoat 104 with impregnation 216 components may be heat treated to convert metal salts into metal oxides. Firing 208 may be done at a temperature between 300° C. and 900° C., and may last from about 2 to about 6 hours for washcoat 104 and impregnation layer 106.

Overcoat

Overcoat 108 may be formed by suspending carrier metal oxides in water to form aqueous slurry, which may be deposited into washcoat 104. The Overcoat 108 may include one or more carrier material oxide or at least one oxygen storage material. Suitable carrier material oxides may include ZrO₂, doped ZrO₂ with Lanthanide group metals, Nb₂O₅, Nb₂O₅—ZrO₂, alumina and doped alumina, TiO₂ and doped TiO₂ or mixtures thereof. A suitable oxygen storage material (OSM) may be a mixture of ceria, zirconia, and lanthanum or ceria, zirconia, neodymium, and praseodymium. The Overcoat 108 may include one or more ZPGM catalyst component. The ZPGM catalyst in Overcoat 108 may prepare by co-precipitation 224, co-milling 226 or any other suitable deposition methods known in the art. The ZPGM transition metal salt or salts may be precipitated with, but is not limited to NH₄OH, (NH₄)₂CO₃, tetraethylammonium hydroxide, other tetraalkylammonium salts, ammonium acetate, or ammonium citrate. Subsequently, the precipitated transition metal salt or salts and Overcoat 108 may be deposited on washcoat 104 followed by a heat treat cycle for about 2 hours to about 6 hours, at a temperature of about 300° C. to about 900° C.

Methods for Preparation of ZPGM Diesel Oxidation Catalyst Systems

Impregnation Method

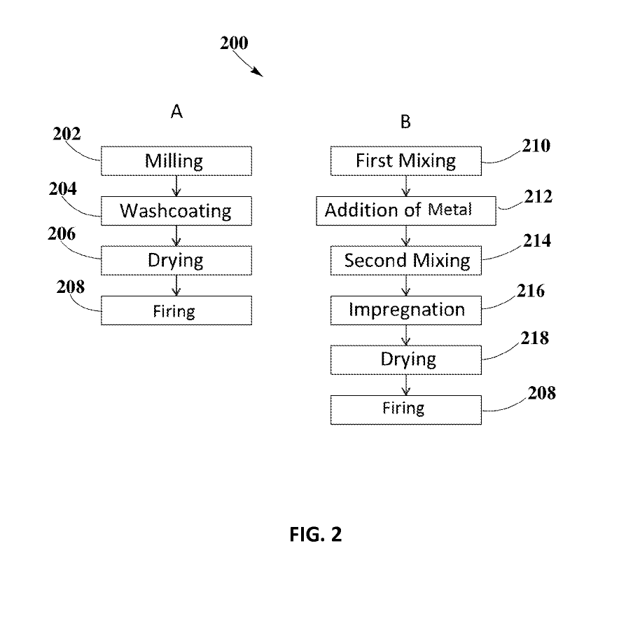

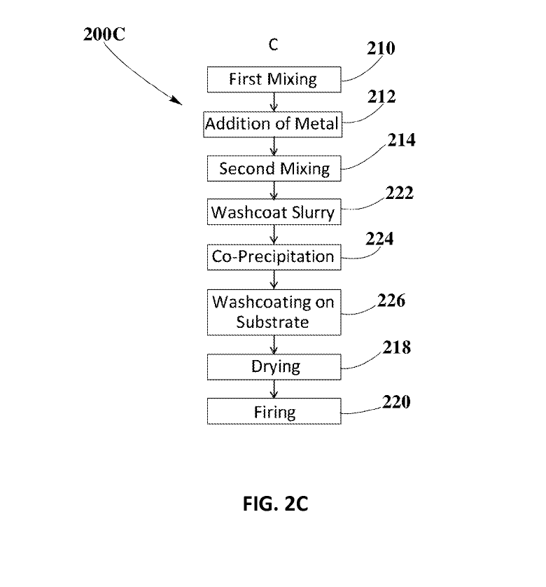

FIG. 2 illustrates method for preparation 200 of ZPGM catalyst system 100, according to an embodiment.

In one embodiment, method for preparation 200 may be a two-step process. FIG. 2A is a washcoat 104 preparation process. In this process, components of washcoat 104 may undergo a milling 202 process in which washcoat 104 materials may be broken down into smaller particle sizes; the mixture may include water, a suitable binder material and a carrier material oxide or OSM, or both. After milling 202 process, an aqueous slurry may be obtained. Milling 202 process may take from about 10 minutes to about 10 hours, depending on the batch size, kind of material and particle size desired. In one embodiment of the present disclosure, suitable average particle size (APSs) of the slurry may be of about 4 microns to about 10 microns, in order to get uniform distribution of washcoat 104 particles. Finer particles may have more coat ability and better adhesion to substrate 102 and enhanced cohesion between washcoat 104 and impregnation layers 106. Milling 202 process may be achieved by employing any suitable mill such as vertical or horizontal mills. In order to measure exact particle size desired during milling 202 process, laser light diffraction equipment may be employed.

After milling 202 process the aqueous slurry may be coated onto a suitable substrate 102 in washcoating 204 step. In this step, the aqueous slurry may be placed on substrate 102 in any suitable manner. For example, substrate 102 may be dipped into the slurry, or the slurry may be sprayed on substrate 102. Other methods of depositing the slurry onto substrate 102 known to those skilled in the art may be used in alternative embodiments. If substrate 102 is a monolithic carrier with parallel flow passages, a washcoat 104 may be formed on the walls of the passages. Followed by a drying 206 step, in which the washcoated substrate 102 may be dried at room temperature. Afterwards, the washcoated substrate 102 may undergo a firing 208 stage, in which the washcoated substrate 102 may be fired at a temperature ranging from 400° C. to 700° C., for approximately 2 hours to 6 hours. In an embodiment, 550° C. for 4 hours.

FIG. 2B is a flowchart of impregnation layer 106 preparation method. The process may start with first mixing 210 step, where an yttrium nitrate solution may be added to a manganese nitrate solution and the solutions may be mixed for a suitable amount of time at room temperature. In some embodiments first mixing 210 process may last from 1 hour to 5 hours. Afterwards, during addition of metal 212 step, a silver nitrate solution or other suitable metal solutions may be added to the mixture of yttrium nitrate and manganese nitrate; then the solution may be mixed at room temperature for about 1 hour to 5 hours, during second mixing 214. When the mixture is ready, it may undergo impregnation 216 process, where the mixture may be impregnated onto a previously washcoated substrate 102. Subsequently, impregnated substrate 102 may be subjected to a drying 218 process and a firing 220 process. Firing 220 process may last between 3 hours and 6 hours, and may be performed and a temperature between 600° C. and 800. According to some embodiments, 4 hours for about 750° C.

Various amounts of washcoats 104 and impregnation layers 106 may be coupled with a substrate 102, preferably an amount that covers most of, or all of, the surface area of a substrate 102. In an embodiment, about 60 g/L to about 250 g/L of a washcoat 104 may be coupled with a substrate 102.

Other components such as acid or base solutions or various salts or organic compounds may be added to the aqueous slurry to adjust the rheology of the slurry and enhance binding of the washcoat 104 and impregnation layer 106 to the substrate 102.

Co-Precipitation Method

In one embodiment, method for preparation 200C may be a one-step process. FIG. 2C is a washcoat 104 preparation process, wherein a ZPGM catalyst of ABO₃ perovskite is precipitated. In this process, components of washcoat 104 including carrier metal oxide (CMO) and water may first undergo a milling process to form washcoat slurry 222. Milling process may take from about 10 minutes to about 10 hours, depending on the batch size, kind of material and particle size desired.

The process of metallization may start with first mixing 210 step, where an yttrium nitrate solution may be added to a manganese nitrate solution and the solutions may be mixed for a suitable amount of time at room temperature. In some embodiments first mixing 210 process may last from 1 hour to 5 hours. Afterwards, during addition of metal 212 step, a silver nitrate solution or other suitable metal solutions may be added to the mixture of yttrium nitrate and manganese nitrate; then the solution may be mixed at room temperature for about 1 hour to 5 hours, during second mixing 214. When the mixture is ready, it may undergo metallization process by adding the Y—Ag—Mn solution to washcoat slurry 222. Metallization process may last from 1 hour to 5 hours, followed by co-precipitation 224 in presence of suitable compounds. Suitable compounds for co-precipitation 224 of metal salts may include tetraethylammonium hydroxide, other tetraalkylammonium salts, ammonium acetate, ammonium citrate, sodium hydroxide, sodium carbonate and other suitable compounds known in the art.

After co-precipitation 224 process, the aqueous slurry may be coated onto a suitable substrate 102 in washcoating on substrate 226 step, followed by a drying 218 step, in which the washcoated substrate 102 may be dried at room temperature. Afterwards, the washcoated substrate 102 may undergo a firing 220 stage, in which the washcoated substrate 102 may be fired at a temperature ranging from 600° C. to 800° C., for approximately 2 hours to 6 hours. In one embodiment, 750° C. for 4 hours.

### EXAMPLES

Example 1 is a ZPGM catalyst system 100, prepared by impregnation 216 method described in FIG. 2A and FIG. 2B. Washcoat 104 includes at least a carrier material oxide, such as zirconia and may include a binder or small amount of rheology adjustment additives. Rheology adjustment additives may include acids, among other suitable substances. This catalyst system is free of any oxygen storage material. The milled zirconia slurry is deposited on the cordierite substrate 102 in the form of a washcoat 104 and then heat treated. This treatment may be performed at about 400° C. to about 700° C. In some embodiments this treatment may be performed at about 550° C. The heat treatment may last from about 2 to about 6 hours. In an embodiment the treatment may last about 4 hour. The impregnation layer 106 includes at least yttrium, silver and manganese. The yttrium in impregnation layer 106 is present in about 1% to about 10%, by weight. The silver in impregnation layer 106 is present in about 1% to about 10%, by weight. The manganese in impregnation layer 106 is present in about 1% to about 10%, by weight. The impregnation 216 components may be mixed together following the process described in FIG. 2B. After deposition of impregnation 216 component on to washcoat 204 the ZPGM catalyst system 100 may be dried and heat treated. This treatment may be performed at about 400° C. to about 800° C. In some embodiments this treatment may be performed at about 750° C. The heat treatment may last from about 2 to about 6 hours. In an embodiment the heat treatment may last about 4 hours. The resulting ZPGM catalyst system 100 has a perovskite structure Y_{0.8}Ag_{0.2}MnO₃.

Example 2 is a ZPGM catalyst system 100, prepared by co-precipitation 224 method described in FIG. 2C and include substrate 102 and washcoat 104. Washcoat 104 includes at least a carrier material oxide, such as zirconia and ZPGM catalyst with perovskite structure. Washcoat 104 may include a binder or small amount of rheology adjustment additives. This catalyst system is free of any oxygen storage material. The milled zirconia slurry is mixed with aqueous solution of at least yttrium nitrate, silver nitrate and manganese nitrate, followed by precipitation by tetraethylammonium hydroxide. The pH of slurry adjusted at approximately neutral condition. The yttrium in washcoat 104 is present in about 1% to about 10%, by weight. The silver in washcoat 104 is present in about 1% to about 10%, by weight. The manganese in washcoat 104 is present in about 1% to about 10%, by weight. The washcoat 104 is deposited on the cordierite substrate 102 and then heat treated. This treatment may be performed at about 600° C. to about 800° C. In some embodiments this treatment may be performed at about 750° C. The heat treatment may last from about 2 to about 6 hours. In an embodiment the heat treatment may last about 4 hours. The resulting ZPGM catalyst system 100 has a perovskite structure Y_{0.8}Ag_{0.2}MnO₃.

Example 3 is a ZPGM catalyst system 100, prepared by impregnation 216 method described in FIG. 2A and FIG. 2B. Washcoat 104 includes at least a carrier material oxide, such as zirconia and may include a binder or small amount of rheology adjustment additives. Rheology adjustment additives may include acids, among other suitable substances. This catalyst system is free of any oxygen storage material. The milled zriconia slurry is deposited on the cordierite substrate 102 in the form of a washcoat 104 and then heat treated. This heat treatment may be performed at about 400° C. to about 700° C. In some embodiments this heat treatment may be performed at about 550° C. The heat treatment may last from about 2 to about 6 hours. In an embodiment the treatment may last about 4 hour. The impregnation layer 106 includes at least yttrium and manganese. The yttrium in impregnation layer 106 is present in about 1% to about 10%, by weight. The manganese in impregnation layer 106 is present in about 1% to about 10%, by weight. The impregnation components may be mixed together following the process described in FIG. 2B. After deposition of impregnation component on to washcoat 104 the ZPGM catalyst system 100 may be dried and heat treated. This heat treatment may be performed at about 400° C. to about 800° C. In some embodiments this treatment may be performed at about 750° C. The heat treatment may last from about 2 to about 6 hours. In an embodiment the treatment may last about 4 hours. The resulting ZPGM catalyst system 100 has a perovskite structure YMnO₃.

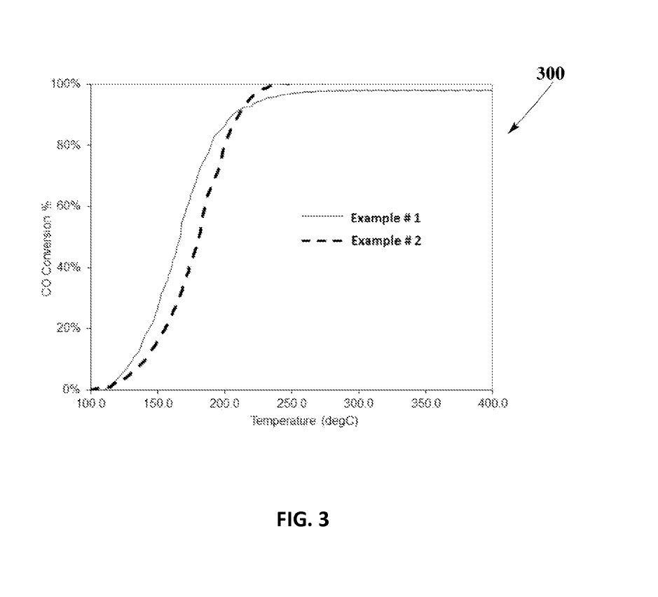

FIG. 3 shows the CO light-off test results 300 for the ZPGM catalyst system 100 of example #1 and example #2 for fresh sample. The light-off test is performed under simulated DOC condition. Feed stream includes of 150 ppm NO, 1500 ppm of CO, 430 ppm of C₃H₆ as hydrocarbon, 4% CO₂, 4% of H₂O and 14% of oxygen. The test is performed by increasing the temperature from about 100° C. to 400° C. at a constant rate of 20° C./min. The CO light-off test results 300 show that the ZPGM catalyst system 100 of example 1 has higher CO conversion. The T50 for CO is 167° C. and 181° C. for ZPGM catalyst of Example #1 and Example #2, respectively. The results show the influence of preparation method on CO conversion.

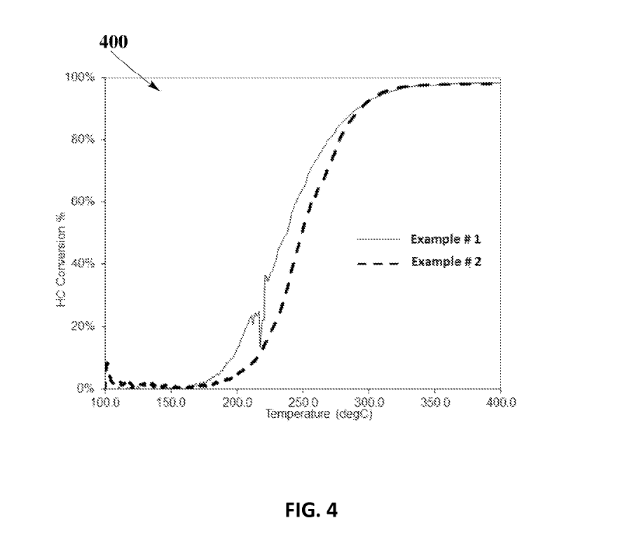

FIG. 4 shows the HC light-off test results 400 for the ZPGM catalyst system 100 of example #1 and example #2 for fresh sample. The light-off test is performed under simulated DOC condition. Feed stream includes of 150 ppm NO, 1500 ppm of CO, 430 ppm of C₃H₆ as hydrocarbon, 4% CO₂, 4% of H₂O and 14% of oxygen. The test is performed by increasing the temperature from about 100° C. to 400° C. at a constant rate of 20° C./min. The HC light-off test results 400 show that the ZPGM catalyst system 100 of example 1 has higher HC conversion. The T50 for HC is 238° C. and 249° C. for ZPGM catalyst of Example #1 and Example #2, respectively. The results show the influence of preparation method on hydrocarbon conversion.

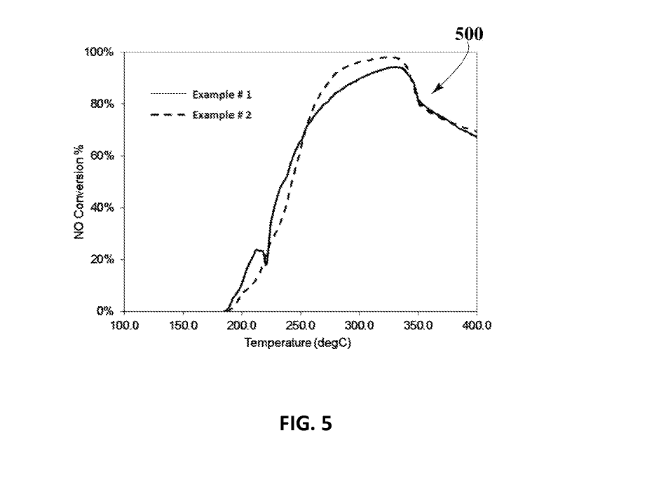

FIG. 5 shows the NO light-off test results 500 for the ZPGM catalyst system 100 of example #1 and example #2 for fresh sample. The light-off test is performed under simulated DOC condition. Feed stream includes of 150 ppm NO, 1500 ppm of CO, 430 ppm of C₃H₆ as hydrocarbon, 4% CO₂, 4% of H₂O and 14% of oxygen. The test is performed by increasing the temperature from about 100° C. to 400° C. at a constant rate of 20° C./min. The NO light-off test results 500 show a T50 for NO at 236° C. and 242° C. for ZPGM catalyst of Example #1 and Example #2, respectively. The results show the preparation method does not have significant influence on NO conversion. However, NO light-off test results 500 shows that these catalysts are capable of oxidizing higher percentages of the NO present in an exhaust stream. The analysis of outlet gas confirms formation of only NO2, with no NH3 or N2O formation. Therefore NO conversion related to the oxidation of NO to NO₂, which is important in diesel emission control systems in which NO₂ may be used in CRTs for oxidation of carbon soot.

Engine Dyno Emission Tests

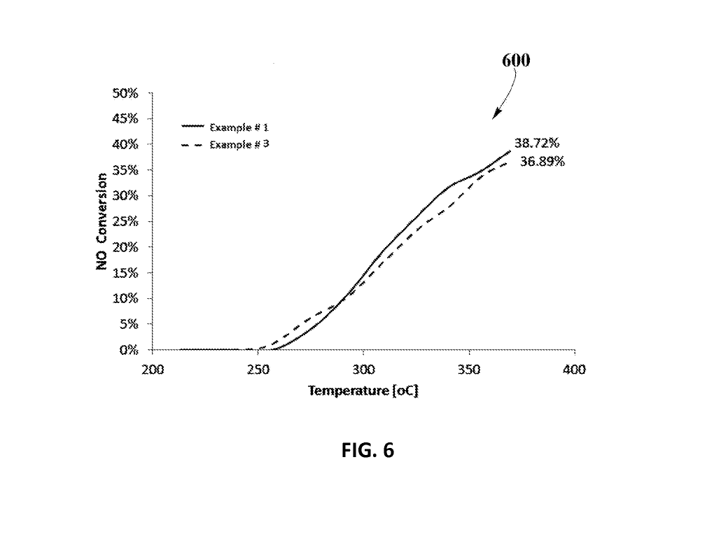

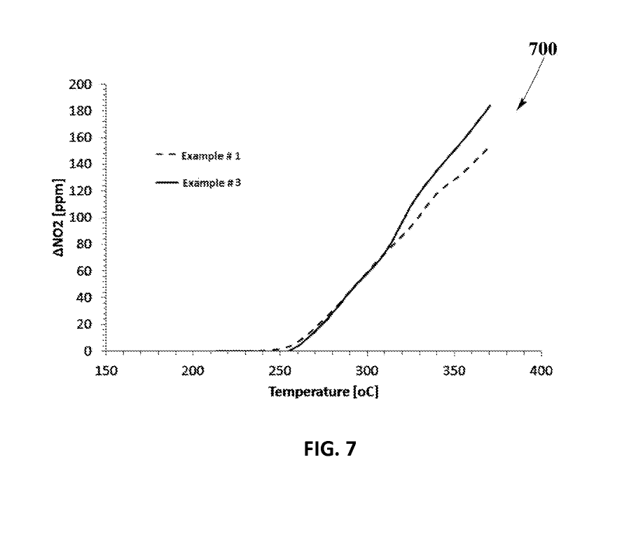

FIG. 6 shows the NO conversion 600 for catalyst of Example #1 and Example #3 under engine dyno emission test. The engine outlet which passing through the catalyst contains 450 to 900 ppm NO, 25 to 70 ppm NO2, 30 to 200 ppm CO, and 50 to 100 ppm hydrocarbone. The temperature varies from 215 C to 370 C and the space velocity varies from 60,000 h⁻¹ to 100,000 h⁻¹. The catalyst of example #1 and example #3 are coated on cordierite substrate with size of 10.5 in×6 in, and volume of 8.5 Liter.

NO conversion 600 shows ZPGM catalyst of example #1 can oxidize NO up to 38.72% and ZPGM catalyst of example #3 can oxidize NO up to 36.89%. The result shows small improvement effect of partial substitution of YMnO₃ perovskite with Ag.

FIG. 7 shows the NO2 generation 700 for catalyst of Example #1 and Example #3 under engine dyno emission test. The engine outlet which passing through the catalyst contains 450 to 900 ppm NO, 25 to 70 ppm NO2, 30 to 200 ppm CO, and 50 to 100 ppm hydrocarbone. The temperature varies from 215° C. to 370° C. and the space velocity varies from 60,000 h⁻¹ to 100,000 h⁻¹. The catalyst of example #1 and example #3 are coated on cordierite substrate with size of 10.5 in×6 in, and volume of 8.5 Liter.

NO2 generation 700 shows ZPGM catalyst of example #1 may produce 152 ppm NO₂ and ZPGM catalyst of example #3 may produce 184 ppm NO₂. The result shows higher formation of NO2 in catalyst with YMnO₃ perovskite structure. The formation of NO2 is important for oxidation of carbon soot.

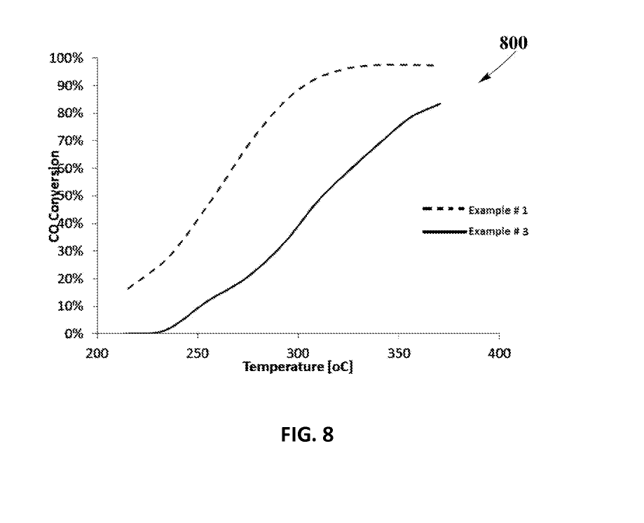

FIG. 8 shows the CO conversion 800 for catalyst of Example #1 and Example #3 under engine dyno emission test. The engine outlet which passing through the catalyst contains 450 to 900 ppm NO, 25 to 70 ppm NO2, 30 to 200 ppm CO, and 50 to 100 ppm hydrocarbone. The temperature varies from 215° C. to 370° C. and the space velocity varies from 60,000 h⁻¹ to 100,000 h⁻¹. The catalyst of example #1 and example #3 are coated on cordierite substrate with size of 10.5 in×6 in, and volume of 8.5 Liter.

CO conversion 800 shows ZPGM catalyst of example #1 can oxidize CO up to 97.24% and ZPGM catalyst of example #3 can oxidize CO up to 83.43%. The result shows significant improvement in CO conversion by partial substitution of YMnO₃ perovskite with Ag.

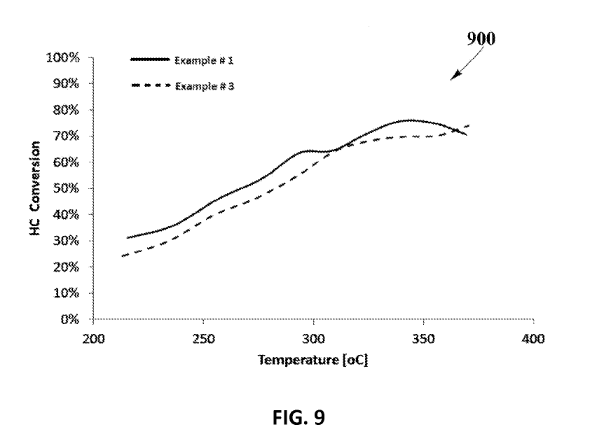

FIG. 9 shows the HC conversion 900 of catalyst of Example #1 and Example #3 under engine dyno emission test. The engine outlet which passing through the catalyst contains 450 to 900 ppm NO, 25 to 70 ppm NO2, 30 to 200 ppm CO, and 50 to 100 ppm hydrocarbone. The temperature varies from 215° C. to 370° C. and the space velocity varies from 60,000 h⁻¹ to 100,000 h⁻¹. The catalyst of example #1 and example #2 are coated on cordierite substrate with size of 10.5 in×6 in, and volume of 8.5 Liter.

HC conversion 900 shows ZPGM catalyst of example #1 and ZPGM catalyst of example #3 can oxidize hydrocarbon up to approximately 73%. However, the result shows overall small improvement effect of partial substitution of YMnO₃ perovskite with Ag in hydrocarbon oxidation.

While various aspects of production methods may be described in the present disclosure, other aspects and embodiments may be contemplated. The various aspects and embodiments disclosed here are for purpose of illustration, and are not intended to be limiting with the scope and spirit being indicated by the following claims.

What is claimed is:

1. An apparatus for reducing emissions from an engine having associated therewith an exhaust system, comprising:
an exhaust source;
a substrate;
a washcoat suitable for deposition on the substrate, comprising at least one oxide solid further comprising at least one carrier metal oxide and at least one first ZPGM catalyst; and
an impregnation layer, comprising at least one second ZPGM catalyst;
wherein at least one of the first ZPGM catalyst and second ZPGM catalyst comprises at least one perovskite structured compound having the formula A₁₋ₓMₓB₃, wherein A is selected from the group consisting of at least one of yttrium, strontium, and combinations thereof, B is selected from the group consisting of at least one of transition metal, M is selected from the group consisting of at least one of silver, iron, copper, cerium, niobium, and combinations thereof, and x is between 0 and 1.

2. The apparatus of claim 1, wherein the at least one transition metal is selected from the group consisting of manganese, cobalt, chromium, and combinations thereof.

3. The apparatus of claim 1, wherein the substrate comprises at least one selected from the group consisting of metallic alloy, microporous material, and combinations thereof.

4. The apparatus of claim 1, wherein the substrate comprises cordierite.

5. The apparatus of claim 1, wherein the at least one perovskite structured compound is of the general formula Y₁₋ₓAgₓMnO₃, wherein x is from 0 to 0.5.

6. The apparatus of claim 5, wherein the at least one perovskite structured compound is applied in the washcoat and the impregnation layer.

7. The apparatus of claim 1, wherein the at least one second ZPGM catalyst comprises about 1% to about 10% by weight yttrium.

8. The apparatus of claim 1, wherein the at least one second ZPGM catalyst comprises about 1% to about 10% by weight manganese.

9. The apparatus of claim 1, wherein the at least one second ZPGM catalyst comprises about 1% to about 10% by weight silver.

10. The apparatus of claim 1, wherein the at least one perovskite structured compound is of the formula Y_{0.8}Ag_{0.2}MnO₃.

11. The apparatus of claim 1, wherein the T50 for CO is about 167° C.

12. The apparatus of claim 1, wherein the T50 for CO is about 181° C.

13. The apparatus of claim 1, wherein the T50 for HC is about 238° C.

14. The apparatus of claim 1, wherein the T50 for HC is about 249° C.

15. The apparatus of claim 1, wherein the substrate has an area of about 60 inches.

16. The apparatus of claim 1, wherein the substrate has a volume of about 8.5 liters.

17. The apparatus of claim 1, wherein the at least one carrier material oxide is selected from the group consisting of ZrO₂, doped ZrO₂ with lanthanide group metals, Nb₂O₅, Nb₂O₅—ZrO₂, alumina, doped alumina, TiO₂, doped TiO₂ and mixtures thereof.

18. The apparatus of claim 1, wherein the impregnation layer further comprises at least one carrier material oxide selected from the group consisting of ZrO₂, doped ZrO₂ with lanthanide group metals, Nb₂O₅, Nb₂O₅—ZrO₂, alumina, doped alumina, TiO₂, doped TiO₂ and mixtures thereof.
